(19) United States
(12) Patent Application Publication
(10) Pub. No.: US 2006/0208910 A1
(43) Pub. Date: Sep. 21, 2006

(54) Pet communication device and associated methods

(76) Inventor: Mark R. Tolner, Windermere, FL (US)

Correspondence Address: JACQUELINE E. HARTT, PH.D;ALLEN, DYER, DOPPELT, MILBRATH & GILCHRIST, P.A., P.O. BOX 3791, ORLANDO, FL, 32802-3791, US

(21) Appl. No.: 11/154,217

(22) Filed: Jun. 16, 2005

Related U.S. Application Data
(60) Provisional application No. 60/658,062, filed on Mar. 1, 2005.

(51) Int. Cl. G08B 23/00; H04M 1/00; H04M 9/00

(52) U.S. Cl. 340/573.3; 379/159; 379/167.01

(57) ABSTRACT

A device for establishing communication between a pet and a person includes a first receiver accessible by routing an incoming call signal thereto. A speaker in communication with the first receiver is provided for broadcasting sounds made by the person to a pet. A call initiating device is actuatable by a pet to emit an output signal for establishing contact with a second receiver for contacting the person. A method for establishing communication between a pet and a person includes routing an incoming call signal from a person to a first receiver. Sounds made by the person are broadcast to a pet using a speaker in communication with the first receiver. The pet is also permitted to contact the person by actuating a call initiating device to emit a predetermined output signal, which is adapted to establish contact with a second receiver accessible by the person.

### CROSS-REFERENCE TO RELATED APPLICATION

This application claims priority to provisional application Ser. No. 60/658,062, filed Mar. 1, 2005, entitled “Pet Communication Device and Associated Methods,” the disclosure of which is incorporated hereinto by reference.

### BACKGROUND OF THE INVENTION

1. Field of the Invention

The present invention relates to devices and methods for establishing remote communication between a pet and a person.

2. Background of the Invention

Consumer spending on pets is a growing phenomenon, and is expected to reach $35.9 billion in 2005, according to BusinessWeek online (“Putting on the Dog,” Stacy Perman, May 13, 2005). It is believed that more people consider pets as family members rather than possessions, and spending on them has increased commensurately.

Since all the adults of many households work outside the home, pet owners worry that the pet may become lonely during the day, and it would be beneficial to address this concern with a device for establishing remote communication between the pet owner and pet. Although devices are known that permit a pet owner to initiate communication with the pet, there is no device known that is initiatable by the pet.

### SUMMARY OF THE INVENTION

The present invention is directed to a device for establishing communication between a pet and a person. The device comprises a first receiver accessible by routing an incoming call signal from a person thereto. A speaker in signal communication with the first receiver is provided for broadcasting sounds made by the person to a pet. A call initiating device is actuatable by a pet to emit a predetermined output signal adapted to establish contact with a second receiver for contacting the person.

A method for establishing communication between a pet and a person comprises the step of routing an incoming call signal from a person to a first receiver. Sounds made by the person are broadcast to a pet using a speaker in signal communication with the first receiver. The pet is also permitted to contact the person by actuating a call initiating device to emit a predetermined output signal. The output signal is adapted to establish contact with a second receiver that is accessible by the person.

The features that characterize the invention, both as to organization and method of operation, together with further objects and advantages thereof, will be better understood from the following description used in conjunction with the accompanying drawing. It is to be expressly understood that the drawing is for the purpose of illustration and description and is not intended as a definition of the limits of the invention. These and other objects attained, and advantages offered, by the present invention will become more fully apparent as the description that now follows is read in conjunction with the accompanying drawing.

### BRIEF DESCRIPTION OF THE DRAWINGS

FIG. 1 is a schematic diagram of an embodiment of the device of the present invention.

FIG. 2 is a schematic diagram of another embodiment of the device of the present invention.

FIGS. 3A,3B is a flowchart of the method of the present invention.

FIG. 4A is a front perspective view of an exemplary call initiating device.

FIG. 4B is a front perspective view of an exemplary programming unit for the device of FIG. 4A.

### DETAILED DESCRIPTION OF THE PREFERRED EMBODIMENTS

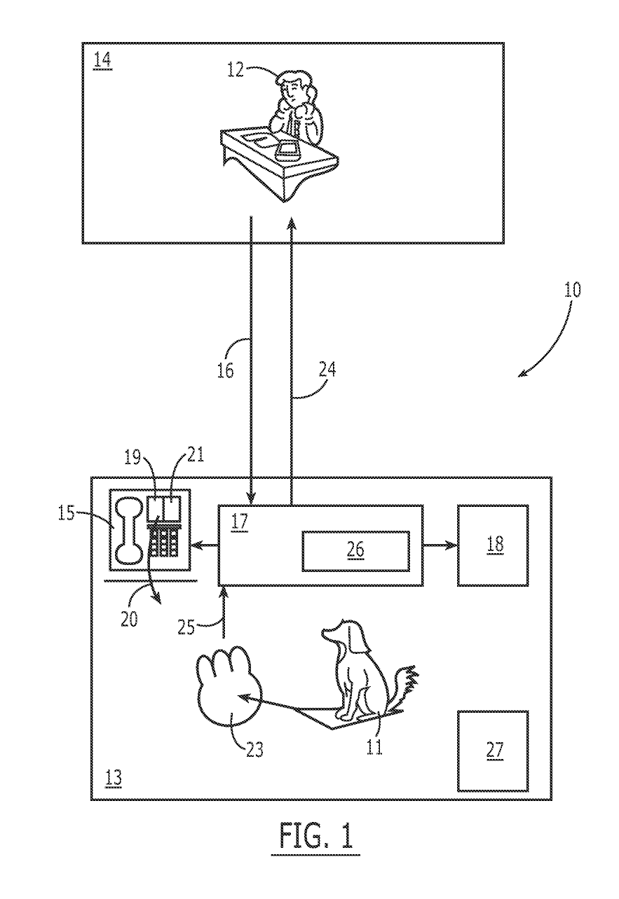

A description of the preferred embodiments of the present invention will now be presented with reference to FIGS. 1-4B.

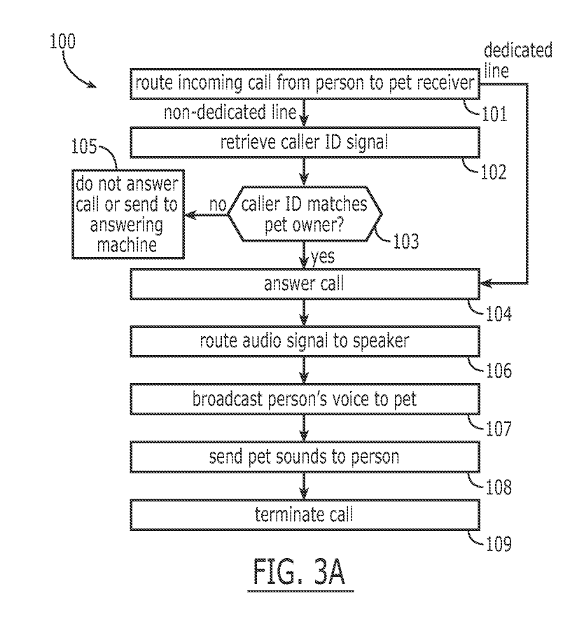

The present invention is directed to a device 10 and method 100 for establishing communication between a pet 11 and a person 12, typically at two different locations 13,14. In an exemplary embodiment, illustrated schematically in FIG. 1, the device 10 comprises a first receiver 15 that is accessible by routing an incoming call signal 16 from the person 12 thereto (block 101, FIG. 3A). In a preferred embodiment, the first receiver 15 comprises a telephone set having a telephone number associated therewith. The first receiver 15 is also under control of a processor 17 that retrieves a caller ID signal (block 102). Upon receipt of a telephone call having a predetermined caller ID associated therewith (block 103), the processor 17 directs the first receiver 15 to answer the call (block 104). If the caller ID is not the predetermined caller ID (block 103), the processor 17 either permits the call to ring unanswered or routes the call to, for example, an answering machine 18 (block 105).

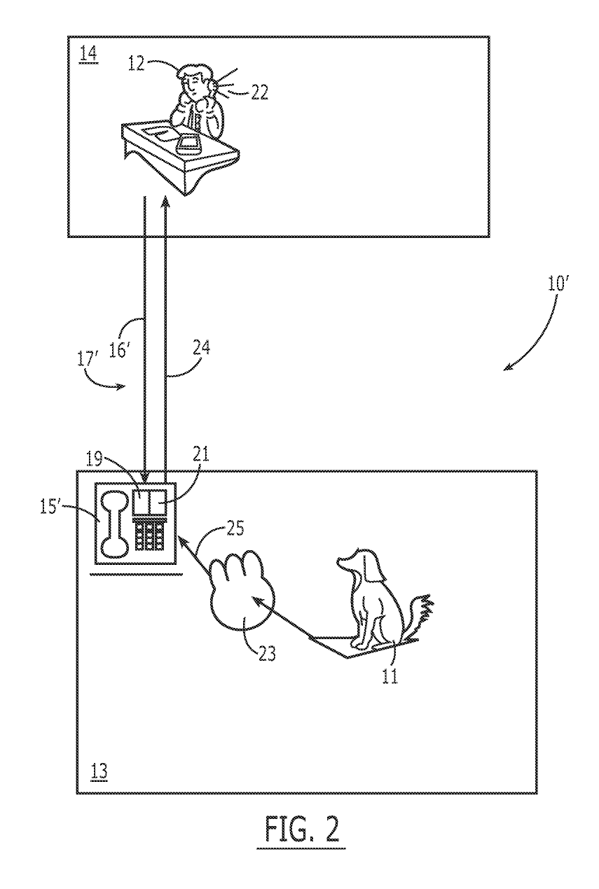

In an alternate embodiment 10′, illustrated schematically in FIG. 2, the first receiver 15′ is in signal communication with a dedicated line 17′ (block 101), so that, when an incoming call signal 16′ is received on the dedicated line 17′, the first receiver 15′ answers the call (block 104).

If the first receiver 15,15′ answers the call, the incoming audio signal is routed to a speaker 19 that is in signal communication with the first receiver 15,15′ (block 106). The speaker 19 is provided for broadcasting sounds 20 made by the person 12 to the pet 11 (block 107).

A microphone 21 is also provided that is in signal communication with the first receiver 15,15′. When the first receiver 15,15′ answers a call, two-way communication is enabled wherein the pet 11 can also transmit sounds 22 to the person 12 (block 108).

The call can be terminated by the person 12 hanging up his/her telephone (block 109).

A call initiating device 23 is actuatable by a pet 11 (block 111, FIG. 3B) to emit a predetermined output signal 24 (block 116) adapted to establish contact with a second receiver 24 to permit the pet 11 to contact the person 12. In a preferred embodiment, a depression of the button “dials” a predetermined, programmable number with an output signal 25. More than one number may be stored for alternate use if, for example, the first number does not answer.

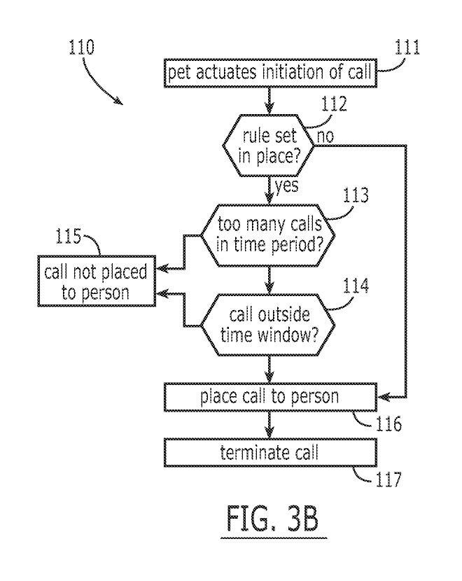

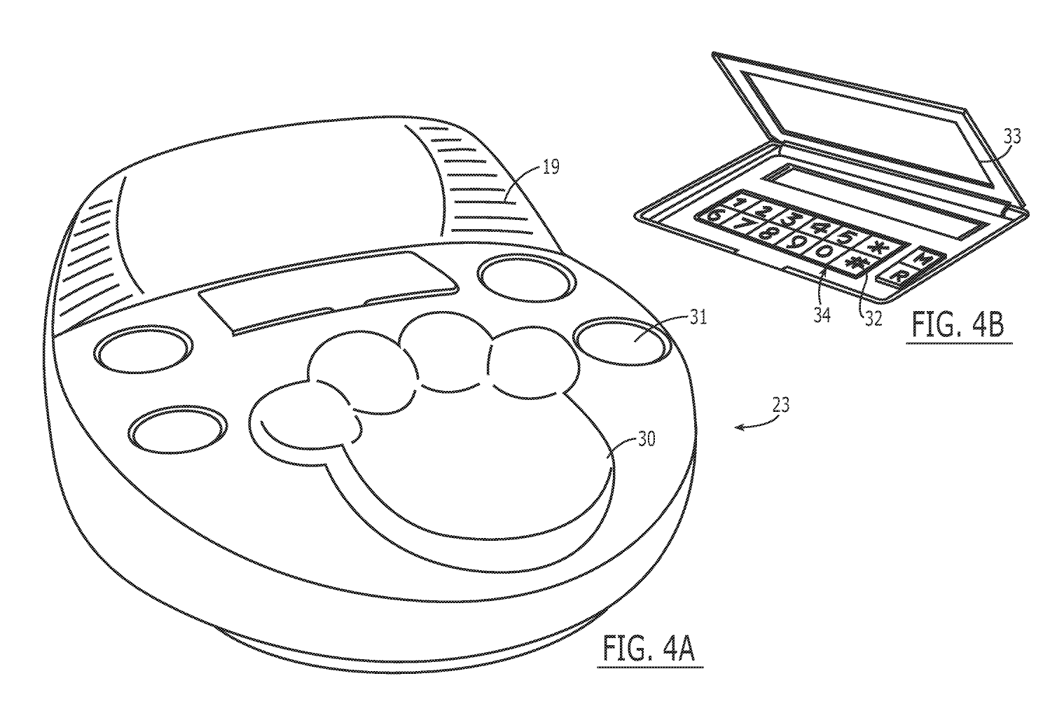

An exemplary call initiating device 23 is illustrated in FIGS. 4A and 4B. The unit 23 comprises in this embodiment a large, paw-shaped button 30 that can be depressed by the pet 11 to place an outgoing call. The unit 23 also includes a speaker 19 and lights 31 for providing additional attraction to the pet when the device 23 signals an incoming call, as is used in telephones for the hearing-impaired. A panel 32 is also provided under a cover 33 to prevent access by the pet 11. The panel 32 includes a touch tone array 34 of numbers and symbols for programming by the pet owner 12. Preferably the device 23 will comprise a heavy-duty material, such as a hard plastic, that is not easily damaged by an over-eager pet 11, and is adapted to be placed on a surface easily accessible by the pet 11, such as the floor.

The call may be terminated by either the pet 11 or the person 12 (block 117).

Preferably the output signal 25 will be disabled from dialing special services such as, but not intended to be limited to, 911, 311, or 411. Other disallowed numbers may also be programmed in.

The processor 17 may also be programmed to accept and/or enforce a rule set 26 (block 112). For example, the rule set 26 may include preventing the pet 11 from making more than a predetermined number of calls within a predetermined time period (block 113), or outside a predetermined time window (block 114), in which case the call is not placed (block 115).

It can be seen by one of skill in the art that the present invention permits the person 12 to provide comfort to a lonely pet 11, and vice versa. Exceptionally intelligent pets could even be trained to use the device 10 under certain conditions, for example, in order to alert the person 12 of a certain condition, for example, if a second person 27 with the pet 11 is in difficulty.

It may be appreciated by one skilled in the art that additional embodiments may be contemplated without departing from the spirit of the invention.

In the foregoing description, certain terms have been used for brevity, clarity, and understanding, but no unnecessary limitations are to be implied therefrom beyond the requirements of the prior art, because such words are used for description purposes herein and are intended to be broadly construed. Moreover, the embodiments of the apparatus illustrated and described herein are by way of example, and the scope of the invention is not limited to the exact details of construction.

Having now described the invention, the construction, the operation and use of preferred embodiments thereof, and the advantageous new and useful results obtained thereby, the new and useful constructions, and reasonable mechanical equivalents thereof obvious to those skilled in the art, are set forth in the appended claims.

What is claimed is:

1. A device for establishing communication between a pet and a person comprising:
a first receiver and a speaker located at a first site;
a call initiating device located at the first site and actuatable by a pet to emit a predetermined output signal;
electronic means for routing an incoming call signal from a person at a second site to the first receiver, for routing an audible signal from the call signal through the speaker for broadcast therefrom to a pet at the first site, and for routing the output signal to a second receiver at a second site for establishing contact with the person at the second site.

2. The device recited in claim 1, wherein the electronic means further comprises means for determining an incoming caller identifier from the incoming call signal and for routing the incoming call signal to the first receiver only if the incoming caller identifier comprises one of a set of predetermined acceptable caller identifiers.

3. The device recited in claim 2, wherein the electronic means further comprises means for, if the incoming caller identifier is not one of the set of predetermined acceptable caller identifiers, routing the incoming call signal to an answering device.

4. The device recited in claim 1, further comprising a microphone in signal communication with the electronic means, and wherein the electronic means is further adapted to route an audible pet signal received by the microphone to the second receiver during established contact with the second site.

5. The device recited in claim 1, wherein the electronic means is further adapted to receive a call termination signal from the first receiver generated from the second site, and for terminating contact between the person and the pet upon receipt of a call termination signal.

6. The device recited in claim 1, further comprising a housing for encasing the first receiver, the speaker, and at least some of the electronic means, and wherein the call initiating device comprises a contact element in signal communication with the electronic means and an actuator movable between an open position and a depressed position in contact with the contact element wherein an output signal is generated upon contact between the actuator and the contact element.

7. The device recited in claim 6, wherein the actuator comprises a button positioned on an upper face of the housing, the button depressable upon pressure exerted by a pet paw.

8. The device recited in claim 6, wherein the electronic means further comprises a programming element positioned within the housing for entering an acceptable caller identifier, means for determining an incoming caller identifier from the incoming call signal, and means for routing the incoming call signal to the first receiver only if the incoming caller identifier comprises the acceptable caller identifier.

9. The device recited in claim 8, wherein the housing further comprises a cover removably positionable over the programming element, for preventing pet access thereto.

10. The device recited in claim 8, wherein electronic means further comprises means for receiving from the programming element a rule set for determining whether an output signal is routed to the second receiver.

11. The device recited in claim 10, wherein the rule set comprises one of frequency and temporal call restrictions.

12. A method for establishing communication between a pet and a person comprising the steps of:
routing an incoming call signal from a person at a second site to a first receiver at a first site housing a pet;
broadcasting sounds made by the person via the incoming call signal to the pet at the first site using a speaker in signal communication with the first receiver; and
routing an output signal generated by the pet to a second receiver at the second site for permitting the pet to contact the person at the second site.

13. The method recited in claim 12, further comprising the steps of determining an incoming caller identifier from the incoming call signal and routing the incoming call signal to the first receiver only if the incoming caller identifier comprises one of a set of predetermined acceptable caller identifiers.

14. The method recited in claim 13, further comprising the step of, if the incoming caller identifier is not one of the set of predetermined acceptable caller identifiers, routing the incoming call signal to an answering method.

15. The method recited in claim 12, further comprising the step of routing an audible pet signal received by a microphone at the second site to the second receiver during established contact with the second site.

16. The method recited in claim 12, further comprising the steps of receiving a call termination signal from the first receiver generated from the second site, and terminating contact between the person and the pet upon receipt of a call termination signal.

17. The method recited in claim 12, wherein the output signal routing step comprises permitting the pet to contact a call initiating device in signal communication with a signal generator for generating the output signal.

18. The method recited in claim 17, wherein contact-permitting step comprises providing a button positioned for depression on the call initiating device by pressure exerted by a pet paw.

19. The method recited in claim 17, further comprising the steps of programming a processor in signal communication with the call initiating device by entering an acceptable caller identifier, determining an incoming caller identifier from the incoming call signal, and routing the incoming call signal to the first receiver only if the incoming caller identifier comprises the acceptable caller identifier.

20. The method recited in claim 19, further comprising programming the processor with a rule set for determining whether an output signal is routed to the second receiver.

21. The method recited in claim 20, wherein the rule set comprises one of frequency and temporal call restrictions.
